(19) United States
(12) Patent Application Publication
(10) Pub. No.: US 2007/0233777 A1
(43) Pub. Date: Oct. 4, 2007

(54) Methods, systems, and computer program products for dynamically classifying web pages

(75) Inventors: Cary L. Bates, Rochester, MN (US); Paul R. Day, Rochester, MN (US); Byron T. Watts, Byron, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/390,838

(22) Filed: Mar. 28, 2006

(51) Int. Cl. G06F 15/16

(52) U.S. Cl. 709/202

(57) ABSTRACT

A method, system, and computer program product for dynamically classifying web pages associated with a search engine is provided. The method includes calculating a composite respect value for messaging accounts. The calculating includes generating a local respect list for each of the messaging accounts. The local respect list includes a respect quotient assigned to each message sender in the local respect list that indicates a level of deference and esteem afforded to the message sender. The respect quotient is calculated based upon activities conducted by a receiver of at least one message transmitted by the message sender. The calculating also includes periodically querying local respect lists, compiling respect quotients for each message sender, and averaging the compilation. The method also includes calculating a rank for a web page transmitted via a messaging account using a corresponding composite respect value, the page and the rank indexed for searching via a search engine.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to search engines, and particularly to methods, systems, and computer program products for dynamically classifying web pages for a search engine index.

2. Description of Background

Before our invention, search engines were unable to provide adequate information for search requests involving current events which, prior to their occurrence, were relatively obscure or unknown subject matter. Take, for example, an event in which the President of the United States makes a controversial appointment to a cabinet post. Where the general public would be inundated with headlines from newspapers and magazines, a query of the appointee's name via a search engine may yield unsatisfactory results where the appointee came from a position of relative obscurity. This is, in part, because most search engines today use the number of links that point to a site, as well as the popularity of the page from which the link came as a measurement of a site's popularity. Thus, it may be that those web pages which reference the appointee were ranked low by the search engine, as the corresponding sites were determined to have fewer ‘hits’ than other sites. While this ranking technique used by search engines has provided some benefit in its ability to highlight quality sites for the general public, those sites that are relatively new or of interest only because of current events are often not ranked as high as they should be at a given time. What is needed, therefore, is a more dynamic method of ranking sites that is capable of automatic adjustment of site rankings in order to enable optimum search results.

### SUMMARY OF THE INVENTION

The shortcomings of the prior art are overcome and additional advantages are provided through the provision of a method, system, and computer program product for dynamically ranking, and adjusting the ranking of, web sites via a search engine classification system. The method includes calculating a composite respect value for messaging accounts. The calculating includes generating a local respect list for each of the messaging accounts. The local respect list includes a respect quotient assigned to each message sender in the local respect list that indicates a level of deference and esteem afforded to the message sender. The respect quotient is calculated based upon activities conducted by a receiver of at least one message transmitted by the message sender. The calculating also includes periodically querying local respect lists, compiling respect quotients for each message sender, and averaging the compilation. The method also includes calculating a rank for a web page transmitted via a messaging account using a corresponding composite respect value, the page and the rank indexed for searching via a search engine.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which dynamically ranks, and adjusts the rankings of, web sites via a search engine classification system. The system calculates a respect value for messaging accounts, assesses the relevance of messaging content including web pages and Uniform Resource Locators (URLs) transmitted via the messaging accounts, and utilizes the results of the calculations and assessments to rank the web pages/web sites at a search engine index.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system upon which the web content classification system may be implemented in exemplary embodiments; and

FIG. 2 illustrates one example of a flow diagram describing a process for implementing the web content classification system in exemplary embodiments.

The detailed description explains the preferred embodiments of the invention, together with advantages and features, by way of example with reference to the drawings.

### DETAILED DESCRIPTION OF THE INVENTION

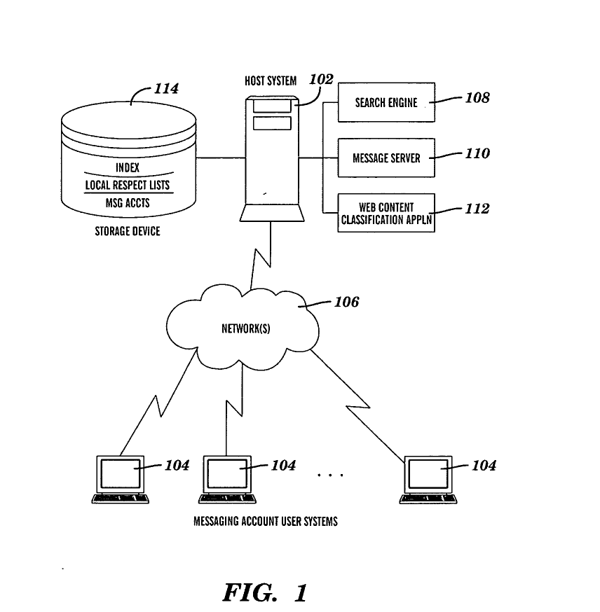

Turning now to the drawings in greater detail, it will be seen that in FIG. 1 there is a system upon which the web content classification system may be implemented in exemplary embodiments. The system of FIG. 1 includes a host system 102 in communication with messaging account user systems 104 (also referred to herein as “user systems”) over one or more networks 106. Host system 102 may be a high speed processing device (e.g., a mainframe computer) that handles large volumes of processing requests from user systems 104. In exemplary embodiments, host system 102 functions as an applications server, web server, and database management server. In exemplary embodiments, the host system 102 is implemented by a web portal service provider enterprise that provides a variety of services to Internet users, such as email or other messaging tools (e.g., instant messaging, chat rooms, etc.), a search engine, online shopping, and news, to name a few. While only a single host system 102 is shown in the system 100 of FIG. 1, it will be understood that multiple host systems may be implemented, each in communication with one another via direct coupling or via one or more networks. For example, multiple host systems may be interconnected through a distributed network architecture.

User systems 104 may comprise desktop or general-purpose computer devices that generate data and processing requests, such as requests to perform searches. For example, user systems 104 may request web pages, documents, and files that are stored in various storage systems whereby each of the storage systems may be serviced by one or more servers located anywhere on the network(s). In addition, individuals at user systems 104 conduct communications activities via messaging accounts (e.g., email accounts) provided by the host system 102.

Network(s) 106 may be any type of communications network known in the art. For example, network(s) 106 may be an intranet, extranet, or an internetwork, such as the Internet, or a combination thereof. Network(s) 106 may be wireless, wireline, or a combination thereof.

In exemplary embodiments, host system 102 executes various applications, including a search engine 108, a messaging server 110, and a web content classification application 112. Other applications, e.g., business applications, may also be implemented by host system 102 as dictated by the needs of the enterprise of the host system 102. The search engine 108 may be a commercial product or may be a proprietary tool used by the enterprise of host system 102. Message server 110 facilitates communications among messaging account holders (e.g., user systems 104) of the host system 102. For example, message server 110 receives messages from account holders (message senders) and directs the messages to the inboxes of other account holders (message receivers) that are serviced by the host system 102.

Web content classification application 112 facilitates the site classification activities described herein using information derived from account holders of the messaging system users, among other information. Thus, if search engine 108 and/or message server 110 utilize commercial or off-the-shelf products, web content classification application 112 may include an application programming interface (API) for facilitating information transfer among these applications. If the search engine 108 and the message server 110 utilize proprietary products, these products may be configured or adapted to communicate with the web content classification application 112 as needed. It will be understood that web content classification application 112 may be adapted to receive information from external mail system servers (e.g., communications associated with senders/receivers of communications that transpire between the network of account holders of the host system messaging system and external communications service providers (e.g., a POP server external to the host system).

The web content classification application 112 monitors messaging account activities and builds local respect lists for each messaging account holder based upon the activities. The web content classification application 112 further includes logic for evaluating the activities and calculating a relevance of links, or web pages, that are included in messages transmitted among account holders as described further herein.

Host system 102 is also in communication with storage device 114. Storage device 114 may comprise one or more repositories of information utilized by each of the search engine 108, messaging server 110, and web content classification application 112. For example, storage device 114 may store a classification index generated by search engine 108. The classification index may include a listing of key search terms along with associated URLs and ranking information that determines where in a search result each URL is be placed. Typical ranking information may include the number of occurrences of a particular key word in a web page and the number of hits associated with a page. As described herein, the web content classification application 112 provides a third dimension to the ranking of web pages listed in the index. This third dimension involves factoring into the ranking messaging activities that occur with respect to a particular web page. As shown in the system of FIG. 1, storage device 114 stores local respect lists generated by the web content classification application 112, as well as messaging account information (e.g., email account holder information, message inboxes, etc.).

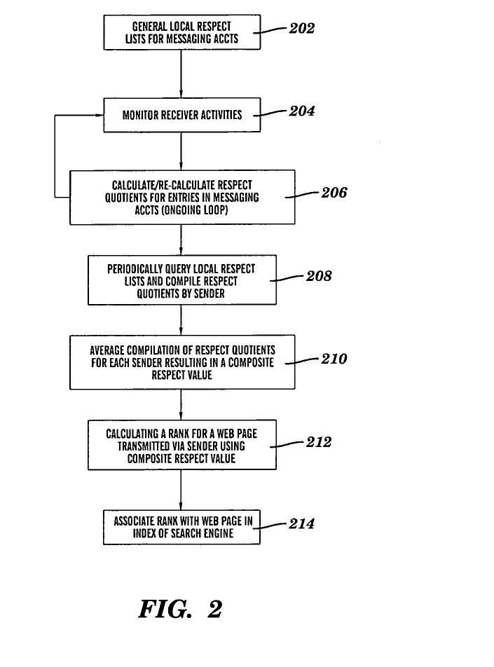

Turning now to FIG. 2, a flow diagram describing a process of implementing the web content classification activities will now be described in exemplary embodiments. At step 202, the web content classification application 112 generates local respect lists for each of the messaging accounts. The local respect lists include identifiers of senders for each communication in a receiving account holder's inbox. The identifiers may be assigned in a manner that protects the privacy and identity of the account holder.

At step 204, the web content classification application 112 monitors messaging activities performed by account holders of the messaging services provided by host system 102. The monitoring includes identifying web pages or URLs embedded in the body of a message communication conducted among account holders. The monitoring also includes tracking activities performed by account holders with respect to incoming messages. For example, the web content classification application 112 may track the amount of time each message sits in the receiver's inbox before the receiver opens the message. The tracking may also include identifying which messages are opened, which messages are deleted with and/or without first being opened, and which links or URLs contained in the messages are deleted with and/or without first being accessed. The tracking may also include determining the order in which the receiver opens messages in the inbox, implying a priority afforded to particular senders.

The web content classification application 112 also evaluates the substance of the link or URL as part of the monitoring. The web content classification application 112 also compares the origin of the link with the sender of the message containing the link to determine whether the sender may be the owner of the web site or link. This information may be useful in assessing the quality (and ultimately, the ranking) of the web site.

At step 206, the web content classification application 112 calculates a respect quotient for each sender based upon the monitoring and tracking activities described above in step 204. The respect quotient indicates a level of deference and esteem that is attributed to the sender as determined by the activities conducted by the message receiver. For example, a receiver may open or access a message transmitted by Sender A immediately upon receipt. Or, a receiver may open or access a message transmitted by Sender A prior to opening other messages stored in the inbox despite the fact that the other messages may have been received earlier in time than the message from Sender A. This action may imply that the receiver considers Sender A to be a ‘preferred’ or valued individual. Conversely, the receiver may delete a message received by Sender B without first opening it. This implies a low level of preference given by the receiver to Sender B. Thus, the activities conducted by the receiver while utilizing his/her messaging account may provide useful information in determining the value or respect level of a particular sender. Likewise, this respect level may be transferred to the content of the messages conveyed by the sender. Accordingly, the web content classification application 112 assigns a respect quotient to each sender that is subsequently used to rank the content transmitted by the sender.

The respect quotient may be calculated using various techniques. For example, a weighting factor may be applied to various activities conducted by the receiver, such that senders of messages that are opened within a specified period of time are assigned a higher weight (and respect value) than those senders whose messages were deleted without being opened. As indicated above, the identity of the sender (e.g., as an owner of the link conveyed in a message) may be used in a weighting algorithm for determining the respect quotient. Other factors may be utilized in determining a respect quotient. For example, if a receiver of a message transfers the message to a junk mail or spam folder, the sender of that message may be afforded a low respect quotient.

As shown in FIG. 2, the respect quotient for each sender may be re-calculated as new messages are delivered and processed by a receiver of the messages with respect to a particular sender (whereby the process returns to step 204). Thus, if Sender A sends a second message that is not opened by the receiver for 10 days, the respect quotient may be adjusted to reflect a lower value.

At step 208, the web content classification application 112 periodically queries the local respect lists at each account and compiles the respect quotients by sender. For example, suppose Sender A transmitted a message to a distribution list that includes 20 recipients. Each of the 20 recipients has associated local respect lists containing a respect quotient for the sender. The web content classification application 112 compiles the respect quotients from each account for Sender A, as well as other senders.

At step 210, the web content classification application 112 averages the compilation of respect quotients for each sender resulting in a composite respect value. The composite respect value determines the overall level of deference and esteem given to each sender as determined by the collective activities of each of the corresponding recipients, as well as any other factors considered to be relevant in the assessment.

At step 212, a rank is calculated for one or more web pages transmitted by each sender using the composite respect value. Generally, those web pages associated with a highly-regarded sender will be given a higher ranking than web pages associated with a sender with a low respect value. Various methods may be employed in determining a particular rank for a web page. By way of example, the web content classification application 112 may be configured to determine the number of receivers who received a web page or link from a sender and divide this number by the total sum of receivers who received all URLs or web pages sent by the sender. In this manner, each recipient that received the link would contribute some adjustment to that page's available rank. Page rank may also depend on the placement of the URL within the message. For example, URLs located in the signature section of a message may be given less weight than the URLs occurring in the body of a message. In addition, page rank may also be correlated to text attributes of a URL occurring in the body of a message. An example of a text attribute might be a change in font size whereby the font size of the URL is larger or smaller than that of the font size of the text in the body of the message. Another example of a text attribute might be a color difference between the URL and the surrounding text, or that the link is attached to an image. Also, the words surrounding the link may be parsed in order to rank the link according to certain phrases or key words, such as “I love this link” or “I have gone here many times and highly recommend it.” These types of key words might increase the rank. Likewise, negative phrases such as “this is not a good link” or “I do not recommend this link” might reduce the rank of the link.

The ranking is associated with the web page in the index of the search engine (e.g., in storage device 114) at step 214. The rankings may be re-calculated periodically based upon need.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for dynamically classifying web pages associated with a search engine, comprising:
calculating a composite respect value for each of a plurality of messaging accounts, comprising:
generating a local respect list for each of the plurality of messaging accounts, the local respect list including a respect quotient assigned to each message sender in the local respect list, the respect quotient indicating a level of deference and esteem afforded to the message sender and calculated based upon activities conducted by a receiver of at least one message transmitted by the message sender; wherein the receiver holds one of the plurality of messaging accounts;
periodically querying local respect lists and compiling respect quotients for each message sender; and
averaging the compilation of respect quotients resulting from the querying; and
calculating a rank for a web page transmitted via at least one of the plurality of messaging accounts using a corresponding composite respect value, the page and the rank indexed for searching via a search engine.

2. The method of claim 1, wherein the messaging accounts comprise at least one of email accounts and instant messaging accounts.

3. The method of claim 1, wherein time measurements taken with respect to the activities factor into the respect quotient, the activities including:
opening a message received from the message sender;
opening a link to the web page received in the message from the message sender;
deleting a message received from the message sender;
deleting a message that contains a link to the web page without first accessing the link;
deleting a message that contains a link to the web page after accessing the link; and
transferring a message to a junk or Spam folder;
wherein the timing of the opening and deleting, and the response of the receiver in taking action after the opening, are compared to activities conducted with respect to messages from other senders.

4. The method of claim 3, wherein the order in which the receiver opens messages is factored into the respect quotient.

5. The method of claim 1, wherein the rank is calculated by dividing a total number of receivers of a web page sent from a sender by a total sum of receivers who received all web pages sent from the sender.

6. The method of claim 1, wherein the calculating a rank for a web page further includes assigning a weight to the web page based upon at least one of:
placement of a uniform resource locator of the web page within a message; and
text attributes of a uniform resource locator including at least one of:
font size;
font color; and
content.

7. A system for dynamically classifying web pages associated with a search engine, comprising:
a web content classification application executing on a host system, the host system executing a search engine and a mail server, the web content classification application performing:
calculating a composite respect value for each of a plurality of messaging accounts implemented by the mail server, comprising:
generating a local respect list for each of the plurality of messaging accounts, the local respect list including a respect quotient assigned to each message sender in the local respect list, the respect quotient indicating a level of deference and esteem afforded to the message sender and calculated based upon activities conducted by a receiver of at least one message transmitted by the message sender; wherein the receiver holds one of the plurality of messaging accounts;
periodically querying local respect lists and compiling respect quotients for each message sender; and
averaging the compilation of respect quotients resulting from the querying; and
calculating a rank for a web page transmitted via at least one of the plurality of messaging accounts using a corresponding composite respect value, the page and the rank indexed for searching via the search engine.

8. The system of claim 7, wherein the messaging accounts comprise at least one of email accounts and instant messaging accounts.

9. The system of claim 7, wherein time measurements taken with respect to the activities factor into the respect quotient, the activities including:
opening a message received from the message sender;
opening a link to the web page received in the message from the message sender;
deleting a message received from the message sender;
deleting a message that contains a link to the web page without first accessing the link;
deleting a message that contains a link to the web page after accessing the link; and
transferring a message to a junk or Spam folder;
wherein the timing of the opening and deleting, and the response time of the receiver in taking action after the opening, are compared to activities conducted with respect to messages from other senders.

10. The method of claim 9, wherein the order in which the receiver opens messages is factored into the respect quotient.

11. The system of claim 7, wherein the rank is calculated by dividing a total number of receivers of a web page sent from a sender by a total sum of receivers who received all web pages sent from the sender.

12. The system of claim 7, wherein the calculating a rank for a web page further includes assigning a weight to the web page based upon at least one of:
placement of a uniform resource locator of the web page within a message; and
text attributes of a uniform resource locator including at least one of:
font size;
font color; and
content.

13. A computer program product for dynamically classifying web pages associated with a search engine, the computer program product including instructions for implementing:
calculating a composite respect value for each of a plurality of messaging accounts, comprising:
generating a local respect list for each of the plurality of messaging accounts, the local respect list including a respect quotient assigned to each message sender in the local respect list, the respect quotient indicating a level of deference and esteem afforded to the message sender and calculated based upon activities conducted by a receiver of at least one message transmitted by the message sender; wherein the receiver holds one of the plurality of messaging accounts;
periodically querying local respect lists and compiling respect quotients for each message sender; and
averaging the compilation of respect quotients resulting from the querying; and
calculating a rank for a web page transmitted via at least one of the plurality of messaging accounts using a corresponding composite respect value, the page and the rank indexed for searching via a search engine.

14. The computer program product of claim 13, wherein the messaging accounts comprise at least one of email accounts and instant messaging accounts.

15. The computer program product of claim 13, wherein time measurements taken with respect to the activities factor into the respect quotient, the activities including:
opening a message received from the message sender;
opening a link to the web page received in the message from the message sender;
deleting a message received from the message sender;
deleting a message that contains a link to the web page without first accessing the link;
deleting a message that contains a link to the web page after accessing the link; and
transferring a message to a junk or Spam folder;
wherein the timing of the opening and deleting, and the response time of the receiver in taking action after the opening, are compared to activities conducted with respect to messages from other senders.

16. The computer program product of claim 15, wherein the order in which the receiver opens messages is factored into the respect quotient.

17. The computer program product of claim 13, wherein the rank is calculated by dividing a total number of receivers of a web page sent from a sender by a total sum of receivers who received all web pages sent from the sender.

18. The computer program product of claim 13, wherein the calculating a rank for a web page further includes assigning a weight to the web page based upon at least one of:
placement of a uniform resource locator of the web page within a message; and
text attributes of a uniform resource locator including at least one of:
font size;
font color; and
content.
